(19) United States
(12) Patent Application Publication
(10) Pub. No.: US 2013/0286672 A1
(43) Pub. Date: Oct. 31, 2013

(54) CAMERA-BASED HEADLIGHT ADJUSTMENT

(71) Applicant: HELLA KGaA, Lippstadt (DE)

(72) Inventors: Reiner Gödecker, Lippstadt (DE); Carsten Wilks, Lippstadt (DE)

(21) Appl. No.: 13/849,040

(22) Filed: Mar. 22, 2013

(30) Foreign Application Priority Data
Mar. 22, 2012 (DE) 10201202446.4

(51) Int. Cl. F21S 8/10

(52) U.S. Cl. CPC F21S 48/1742
USPC 362/466

(57) ABSTRACT

A method for the adjustment of at least one light device, particularly of a motor vehicle, wherein the light device serves to generate a first light distribution, wherein the first light distribution has a bright/dark boundary (which has defined coordinates on a measurement wall when the light device is optimally adjusted. According to the invention, for this purpose, the camera detects at least one feature of the bright/dark boundary on an arbitrary measurement wall, and the light device is adjusted according to the detected feature.

### CROSS REFERENCE

This application claims priority to German Patent Application No. 10 2012 02446.4, filed Mar. 22, 2012, which is expressly incorporated in its entirety by reference herein.

### TECHNICAL FIELD OF THE INVENTION

The invention relates to a method for the adjustment of at least one light device, particularly of a motor vehicle, wherein the light device serves to generate a light distribution, wherein the light distribution has a bright/dark boundary which has defined coordinates on a measurement wall when the light device is optimally adjusted, and wherein a camera is included in the configuration outside of the light device for the purpose of adjusting the light distribution. In one preferred embodiment, the light device according to the invention can be designed in the form of a headlight of a motor vehicle.

### BACKGROUND OF THE INVENTION

It is known that headlights for vehicles are used to illuminate the road according to the driving situation. The headlights provide various light functions, such as high beams, low beams, and the like. It is important in the implementation of a low beam light, and particularly an adaptive low-beam light, to produce an optimally oriented bright/dark boundary (HDG) in order to sufficiently illuminate the road in front of the vehicle, without also directing excessive light at the oncoming cars or the cars ahead, or directing excessive light at the driver of the vehicle when the vehicle is traveling a bend in the road, as the result of reflection from reflective signs. For stationary low beam lights, it is required by law that the line defined by the bright/dark boundary has an inclination of 1% at a wall 10 meters away, corresponding to an angle of 0.57° or a distance of 10 cm below the height of the installed light device (L, R) [on the vehicle].

During combustion operation [of the vehicle], a motor vehicle headlight can be subjected to various different thermal conditions, both as a result of the heating of the light source and as a result of the temperature of the environment. Temperature variations can result in changes in the volume of the components of the headlight and the fastening devices thereof, which can effect various different changes in volume and/or shape depending on the materials used. These changes can, in turn, lead to an undesired adjustment of the headlight or of the light source housed therein, and subsequently to an undesired displacement of the bright/dark boundary, and to unacceptably excessive light being directed to oncoming traffic and the driver [of the vehicle].

After a certain period of time, therefore, a readjustment of the headlights is necessary, the same having been misadjusted as a result of volume changes of the materials used, or also as a result of changes due to vibration and wear of the components. The readjustment of the headlights is typically carried out in a workshop. Specially marked measurement walls are used for this purpose, wherein the vehicle must be precisely positioned 10 meters in front of the measurement wall, and perpendicular thereto, or alternatively, special optical adjusting devices are used. Methods are also known which enable the driver to undertake the adjustment of the headlights him/herself. By way of example, EP 20 050 618 A2 suggests arranging an additional aperture in front of the light source, wherein said cover can generate a shadow which can be detected by a camera. The position of the headlight is calculated by determining the position of the shadow on the road. The disadvantage of this method is that the headlights must be modified in order to attach this additional aperture. In addition, another disadvantage is that the headlights must be switched to a special mode—a so-called adjustment mode—in order to carry out the measurement. However, the field of vision of the camera does not come near enough to the front of the vehicle, or alternatively the light marking is too far away, and as a result the resolution of the camera is not adequate. In any case, the cover marking produces an inhomogeneity in the light distribution.

Therefore, the problem addressed by the present invention is that of overcoming the described disadvantages of conventional methods. In particular, the problem addressed by the present invention is that of providing a method which enables workshop personnel or even the driver himself/herself to carry out the motor vehicle headlights [sic], in any environment, without special modifications to the headlights.

### SUMMARY OF THE INVENTION

This problem is addressed by a method having the features of claim 1. Advantageous implementations of the invention are indicated in the dependent claims.

The invention includes the technical teaching that the camera can detect at least one feature of the bright/dark boundary on a measurement wall, and that the light device can be adjusted according to the detected feature. The term “measurement wall” should be understood as any arbitrary projection surface wherein the vehicle can be parked approximately perpendicular thereto. An optimally adjusted light distribution has prespecified coordinates on a measurement wall at a given distance therefrom, according to the height of the installed headlight on the vehicle. The first light distribution in the context of the present invention can be a low beam light distribution. The bright/dark boundary of a low beam light in this case has characteristic features in its profile, and these can be depicted as inflection points. The configuration can advantageously include the ability of the camera to detect a second characteristic feature of the light distribution on the measurement wall. According to the invention, the light device can be designed for the purpose of generating a second light distribution—for example a horizontal bright/dark boundary. In this case, the production of the second light distribution can be realized without mechanical pivoting or inclination of the photo-optical axis of the light device (L, R). The two inflection points in the profile of the low beam light, and the inflection point of a vertical bright/dark boundary are each produced by means of a component (an aperture or LED array), and particularly without a movement of the light device. In this case, the abrupt angle transition between the inflection points is prespecified by the construction [of the light] and represents a fixed value which is specific to the device. By comparing the known light displacement to the difference between the determined positions of the two features on the measurement wall, it is possible to calculate the distance of the light device to the measurement wall.

According to the invention, the configuration can include a second light device for the purpose of generating a first light distribution, and particularly a second light distribution, wherein the camera can detect at least one feature of the first and particularly of the second light distribution of the second light device.

In this case, the camera can detect at least one second feature of the first light distribution, and particularly one feature of the second light distribution of the second light device. Motor vehicles typically have two front headlights which implement the light functions, such as low beam and high beam functions. In this case, both light devices can have a specific profile to the bright/dark boundary, wherein the camera can likewise detect the characteristic features of the second light device. The position of the features of the light distribution of the first and the second light device on a measurement wall can provide information about a possible misorientation of the headlights, as well as about the orientation of the vehicle with respect to the wall, and can be used for the purpose of calculating an optimum orientation of the headlights.

The thinking of the invention is based on the camera having the ability to detect characteristic features of the light distribution which are already present. Here, there is no need for a special adjustment marking which should be provided by an additional aperture. There is no need to modify the conventional headlights. In addition, no additional hardware is required to realize this automatic adjustment function. The required software algorithm for the readjustment of the headlights can be advantageously implemented in existing control devices. Parameters which are specific to the vehicle, such as the height of the installed headlights and the distance between the same, as well as the constructive space between the HDG features, can be obtained from the parameter list of the vehicle.

According to the invention, the method can be initiated manually, particularly after a certain number of kilometers traveled by the motor vehicle, preferably after a determined duration of time that the light device has been switched on, and particularly preferably by means of a signal from the vehicle on-board power supply. In this case, the headlight system can provide a signal, for example in the form of an illuminated symbol on the dashboard, in order to alert the driver that the time has come for a required check of the orientation of the headlights and the associated readjustment. Subsequently, the driver can locate a suitable place to park in front of a wall, and manually initiate the readjustment. In order to manually start the method according to the invention, an operating element can be included which likewise can be arranged on the dashboard.

According to the invention, the camera can be attached at a suitable position on the vehicle outside of the headlight and oriented in such a manner that the features of the light distribution are situated in the measuring range of the camera. It is not necessary to precisely orient the camera to the feature being measured. For example, the camera can be attached in the area of the rearview mirror. By comparing the saved original data to the current measured values of the feature, it is possible to detect the orientation and a possible misalignment of the headlights. In the event that the feature being measured is not positioned in the measurement range of the camera, a warning can be given. In this case, a readjustment of the camera is necessary. The camera can be adjusted—on the one hand—automatically by means of an adjusting mechanism. On the other hand, it can be contemplated that the camera is able to be oriented manually by the driver. In this case, the camera should point approximately toward the bright/dark boundary. At least for this measurement task, it is not necessary to precisely orient the camera; the current sighting direction of the camera can be taken into account for the execution of the method.

According to the invention, the camera can act as a sensor to provide the input data for a headlight controller device which can then generate the control data for the movement of the headlights. This control circuit can also be used to monitor the bright/dark boundary in order to recognize possible deviations of the current position from the target position of the features. In the event that a deviation from the target position is detected, a warning signal can be generated in order to inform the drive that the headlight should be readjusted.

In addition, an important advantage of the present invention is that, for the purpose of adjusting the light device, the measured position of the motor vehicle in front of the measurement wall need only be close to the ideal position. The “positioning error” can be automatically taken into account during the determination of the current target value. The vehicle can be positioned at a distance of 2 to 12 meters, and particularly 3 to 10 meters, from the measurement wall, approximately orthogonal thereto.

The measurement wall need not be calibrated, and need not contain any specific markings. Therefore, the driver need not be reliant on a workshop and a specially calibrated measurement wall, and can simply carry out the adjustment in the garage in front of any arbitrary, blank wall.

In order to make it possible to carry out the method according to the invention for the adjustment of the headlights, the driver can first park the vehicle at a suitable distance from any arbitrary measurement wall, approximately orthogonal thereto, wherein said measurement wall should be as even as possible. Next, the driver can manually initiate the method according to the invention, for example by operating an operating element. The method starts with a diagnosis in order to calculate the geometric position of the motor vehicle with respect to the measurement wall and the current orientation of the headlights. Given the determined orientation of the vehicle with respect to the wall, and a known orientation of the camera, it is [then] possible to calculate the prespecified positions of the features in the measuring range of the camera, and it is [then] possible to precisely orient the headlights to these positions.

In the subsequent step of the method according to the invention, one of the features of the light distribution generated by the first light device can be detected. This feature can be an upper or lower inflection point of the low beam light distribution, or an inflection point of the vertical bright/dark boundary, or a prominent feature of any other arbitrary light distribution.

In the subsequent step of the method according to the invention, the same feature of the light distribution generated by the second light device can be detected. If the lower inflection point of the bright/dark boundary of the low beam light has been detected in a previous step, in this step, the lower inflection point should likewise be detected. As an alternative, it can be contemplated that an upper inflection point of the bright/dark boundary of the low beam light, or the inflection point of the vertical bright/dark boundary, is measured.

In the next step of the method according to the invention, a reference angle can be determined for the camera view.

In dynamic headlight systems which have an adaptive forward lighting function and pivoting drive for the headlights, the left and the right headlights can be pivoted by the pivoting drive about the vertical axis until the HDG feature of the first light distribution measured in the first step, and the HDG feature of the second light distribution measured in the second step, once again are positioned at the same pixel column in the measuring range of the camera. The orientation of the camera to this column on the measurement wall can then be saved as the reference angle for the sighting of the camera with respect to the vertical axis (a camera sighting angle of 0°). This camera sighting angle identifies the center of the vehicle on the measurement wall if the camera is arranged centrally with respect to the positions of the headlights on the vehicle. For the case where the camera is not installed centrally on the vehicle, the displacement [thereof] from the center can be incorporated in the calculation; naturally the camera sighting angle is then different from 0°. Upon the orientation of the camera to this column, one feature of the left light device and one feature of the right light device can cover the same area on the measurement wall. The reference angle for the camera view can serve as the reference angle for the orientation of the headlights about the vertical axis. By comparing the camera sighting angles onto the features to the original data for these features, a referencing can be carried out for the pivoting drive. If these features of the left and the right headlights are positioned over each other on this column, at least one of the headlights is set higher than the other. If the features of the left and the right headlights match exactly, then the headlights are set to the same height. It is possible to set an optimum headlight range of the headlights by calculating the target coordinates of the features.

In the next step of the method according to the invention, the pivoting drives of the headlights can now be adjusted about the vertical axis. For this purpose, the camera sighting angles on one of the features of the bright/dark boundary of the two headlights with respect to the vertical axis can be compared.

In this case, one of the headlights—for example the left—can be pivoted out of its current position in such a manner that the first feature of the bright/dark boundary is once again positioned on the pixel column in the measuring range of the camera which corresponds to the preferred orientation of the camera or to the camera sighting angle 0° (without any displacement from center).

The pivot angle is then recorded. Next, the headlight is then pivoted back by the same pivot angle. In order to influence the method as little as possible, the second headlight—in this case the right headlight—can be deliberately pivoted out of the measuring range of the camera.

The camera sighting angle onto the first feature of the bright/dark boundary of the headlight, the same corresponding to the ideal position of the first feature in the measurement field of the camera, is known. By comparison with the actual measured camera sighting angle, it can be determined whether the headlight is pivoted out of the optimum orientation about the vertical axis. If the camera sighting angles agree, then the orientation of the first headlight corresponds to the optimum orientation about the vertical axis. If there is a deviation, the headlight is pivoted out of the optimum position, and the measured camera sighting angle can be saved as the new reference angle for the pivot function of the first headlight.

The same procedure can be carried out for the second headlight. If the measured camera sighting angle corresponds to the known angle, the second headlight is optimally oriented about the vertical axis. If there is a deviation, the second headlight is pivoted out of the optimum position, and the measured camera sighting angle can be saved as the new reference angle for the pivot function of the second headlight.

If the reference angle of the first headlight agrees with the reference angle of the second headlight, the headlights are optimally oriented about the vertical axis. At this point, the next step of the method according to the invention can be initiated as shown below.

However, if the first reference angle does not agree with the second reference angle, at least one of the headlights is pivoted about the vertical axis.

In this case, the reference angle which has the lesser deviation from the ideal position can be utilized as the target value for the two headlights. The previous step should be repeated. It has been discovered that both headlights can advantageously be optimally oriented about the vertical axis usually after one repetition.

In the next step of the method according to the invention, the orientation of the vehicle with respect to the measurement wall can be determined. In this case, the camera sighting angle can be determined for each of the second features of the bright/dark boundary, the upper inflection points of the low beam lights, or the inflection points of the vertical bright/dark boundary of the first and the second headlights. The displacement between the two features of a headlight is predetermined by the construction thereof. The abrupt angle transition between the camera sighting angle onto the first feature and the camera sighting angle onto the second feature of a headlight is therefore known. The abrupt angle transition[s] of the camera sighting angle for the first and the second headlights can be measured and compared. If the two agree, the vehicle is oriented perpendicular to the wall:
if the abrupt angle transition in this case corresponds to that determined by the construction, then the distance to the wall is the same as that during the original setup;
if the abrupt angle transition is smaller than that determined by the construction, then the distance is too short compared to the 10-wall [sic];
if the abrupt angle transition is larger than that determined by the construction, then the distance is too long compared to the 10-wall [sic];
   if the abrupt angle transition[s] of the camera sighting angle for the first and the second headlights do not agree, then the vehicle is offset with respect to the wall:
if the abrupt angle transition on the left is larger than on the right, then the vehicle rear hatch is shifted to the right;
if the abrupt angle transition on the right is larger than on the left, then the vehicle rear hatch is shifted to the left;

As a result, the position of the vehicle with respect to the wall is known, and [it is possible to] optimally orient the headlights of the motor vehicle about the vertical axis. In the final step of the method, it is now possible to adjust the headlight range adjusters of the headlights about the horizontal axis, the same running parallel to the vehicle coordinate system. The determined vehicle position with respect to the measurement wall is the basis for the conversion of the optimal position of the features in the measuring range of the camera. In this case, the headlights which have already been optimally oriented about the vertical axis by means of the pivot drive are set by means of the headlight range adjusters in such a manner that the features of the bright/dark boundary are mapped to the calculated target coordinates. The updated camera sighting angles onto the corresponding features of the first and the second headlights can be saved as the new reference values for the headlight range adjusters.

In the stationary headlight systems which have no pivot drive, the headlights can only be adjusted about the horizontal axis. In this case, the steps for the adjustment of the pivot drive are left out. For each headlight, two features of the bright/dark boundary can be detected by means of the camera. By comparing the distances between two features of a headlight with the original data, the distance of the headlights to the measurement wall can be directly determined. In this case:
if the distance on the left is larger than on the right, then the vehicle rear hatch is shifted to the right;
if the distance on the left is smaller than on the right, then the vehicle rear hatch is shifted to the left;

Once the position of the motor vehicle with respect to the wall is determined, it is then possible to calculate the target coordinates of an optimally adjusted light distribution in the plane of the wall, as well as the camera sighting angle which corresponds with the same. The correction value for the headlight range adjustment is found from a comparison of the current and target values of the theoretical and actual sighting angle. The final step of the method for the dynamic headlight system can be repeated at this point. For the vehicle position as determined with respect to the measurement wall, it is possible to calculate the optimum position of the features in the measurement range of the camera. In this case, the headlights are retracted by means of the headlight range adjusters in such a manner that the features of the bright/dark boundary are mapped to the calculated target coordinates. The updated camera sighting angles onto the corresponding features of the first and the second headlights can be saved as the reference values for the headlight range adjusters.

According to the invention, a control device can be included in the configuration which processes the values measured by the camera and generates corresponding control commands to adjusting devices of the headlight.

These aspects are merely illustrative of the innumerable aspects associated with the present invention and should not be deemed as limiting in any manner These and other aspects, features and advantages of the present invention will become apparent from the following detailed description when taken in conjunction with the referenced drawings.

### BRIEF DESCRIPTION OF THE DRAWINGS

Reference is now made more particularly to the drawings, which illustrate the best presently known mode of carrying out the invention and wherein similar reference characters indicate the same parts throughout the views.

FIG. 1 shows the profile of a bright/dark boundary which produces a first and a second light distribution on a measurement wall;

FIG. 2 shows the determination of the distance to the measurement wall, and

FIG. 3 shows the determination of the position of the center of the vehicle on the projection wall from the sighting view of the camera.

### DETAILED DESCRIPTION

In the following detailed description numerous specific details are set forth in order to provide a thorough understanding of the invention. However, it will be understood by those skilled in the art that the present invention may be practiced without these specific details. For example, the invention is not limited in scope to the particular type of industry application depicted in the figures. In other instances, well-known methods, procedures, and components have not been described in detail so as not to obscure the present invention.

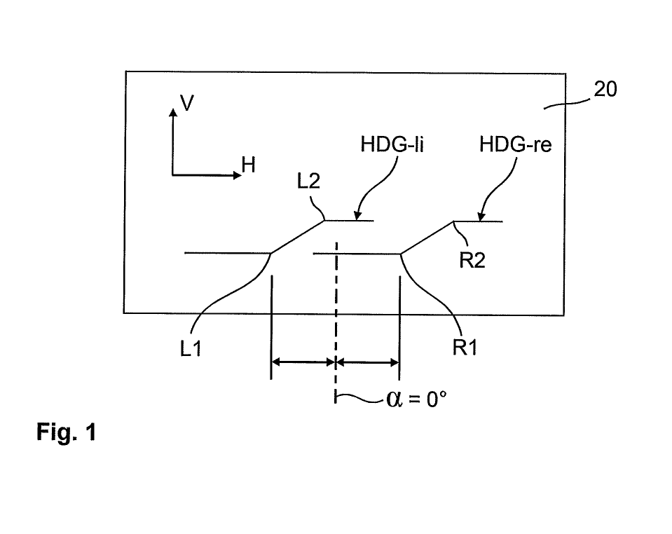

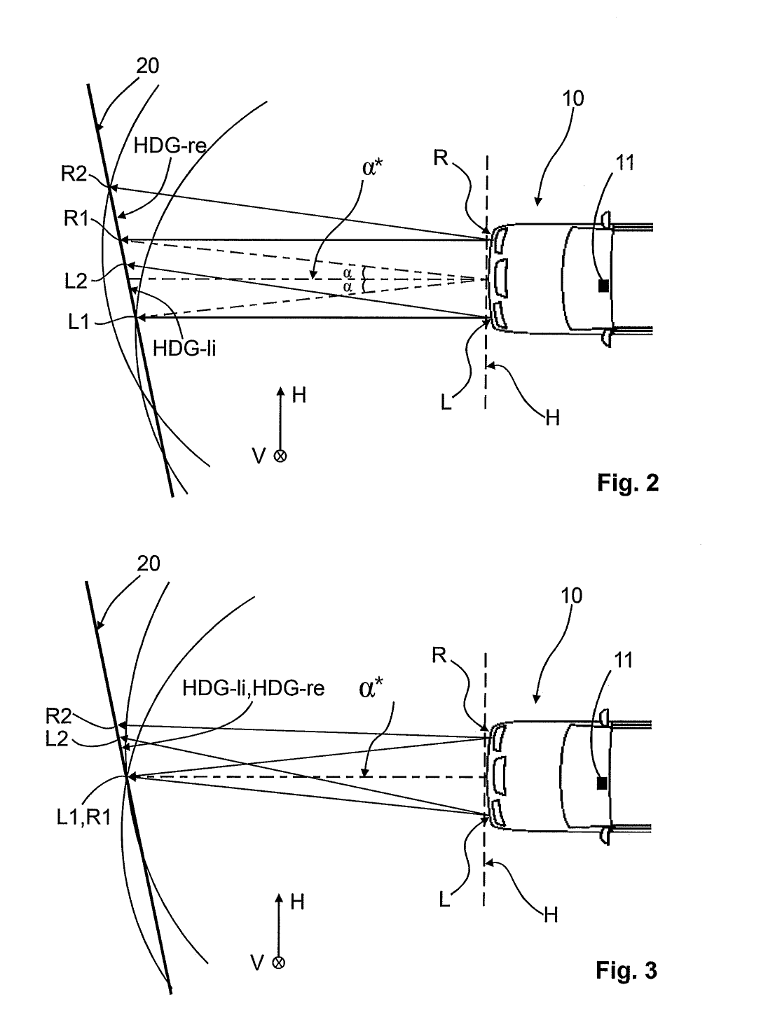

FIG. 1 shows a typical profile of a bright/dark boundary of a low beam light distribution HDG-li, HDG-re which can be produced by the two headlights L, R (see FIG. 2) of a motor vehicle 10 on a measurement wall 20, if the headlights L, R are optimally oriented and the vehicle 10 is positioned perpendicular to the measurement wall 20. The bright/dark boundary of a low beam light distribution HDG-li, HDG-re in this case has two characteristic features L1, L2, R1, R2 in its profile, and these can be depicted as inflection points. Optimally adjusted headlights L, R form a bright/dark boundary HDG-li, HDG-re with inflection points which have specific coordinates on a measurement wall 20 if the height of the headlights, the distance of the vehicle 10 and the orientation of the same to the measurement wall 20 are known.

The invention in this case proceeds from the thinking that a camera 11 can detect these characteristic features L1, L2, R1, R2 of the bright/dark boundary HDG-li, HDG-re, and can provide information about a possible misalignment of the headlights L, R according to the detected coordinates of the features L1, L2, R1, R2 on the measurement wall 20. As such, the configuration advantageously avoids the need to modify the existing headlights in order to arrange an additional aperture which is intended to produce a special adjustment marking. The camera can be arranged in the region of the rearview mirror. It can likewise be contemplated that the camera can be attached at another suitable position on the motor vehicle. If the headlights in this case are optimally oriented, a central camera sighting angle can be determined which can be characterized as a camera reference sighting angle in order to optimally detect two corresponding features L1, R1, or L2, R2. In this case, the preferred camera sighting angle α* between each of two lower inflection points of the bright/dark boundaries HDG-li, HDG-re or between each of the two upper inflection points of the bright/dark boundaries HDG-li, HDG-re, or between two inflection points of the light distributions with vertical bright/dark boundaries, can be selected. In the illustrated example, the preferred camera reference sighting angle α points exactly to the center between two first features L1, R1 of the two light distributions. The dashed line indicates the preferred camera sighting angle α=0°. In this case, the camera sighting angle α onto the first feature L1 of the bright/dark boundary HDG-li, with respect to a vertical axis V, is the same as the camera sighting angle α onto the first feature R1 of the bright/dark boundary HDG-re. The preferred camera sighting angle α* and the camera sighting angle α onto the left lower feature L1 and onto the right lower feature R1, with respect to the vertical axis V, can be saved as reference values for the pivot drive of the headlights L, R. If deviating values are detected in a subsequent measurement with the motor vehicle 10 in the same position, at least one of the pivot drives is misaligned. If the features L1, R1 are not positioned in the same rows in the camera visual field, then at least one of the headlight range adjusters is misaligned.

In practice, a more precise positioning of the motor vehicle at a specific distance and a specific angle to the measurement wall is often difficult.

In addition, it is not possible to ensure the optimal orientation of the camera 11 over a long time. The method according to the invention overcomes these difficulties by taking into account the position of the motor vehicle with respect to the measurement wall, and the orientation of the camera, during the measurement. FIG. 2 shows a vehicle 10 which is parked in front of a measurement wall. The vehicle 10 in the illustrated example is not parked exactly perpendicular to the measurement wall 20. The current central sighting angle α* of the camera 11 is shown by the dashed line, wherein this camera sighting angle α* can deviate from the optimum camera sighting angle α=0°. The left and the right headlights L, R in this case each produce a low beam light distribution which produces a bright/dark boundary HDG-li, HDG-re on the measurement wall 20. The method according to the invention can [now] be started. At first, the orientation of the camera 11 and the current position of the vehicle 10 with respect to the measurement wall 20 are unknown. It is also not known whether the headlights L, R are misaligned. A lower L1, R1 or upper inflection point L2, R2 of the bright/dark boundary HDG-li, HDG-re, or an inflection point of the vertical edge of the vertical bright/dark boundary, can be selected as the feature to be measured. In the examples explained below with reference to FIGS. 2 and 3, the lower inflection point L1, R1 of the bright/dark boundary HDG-li, HDG-re is detected as the first feature. Next, a second feature of the bright/dark boundary HDG-li, HDG-re can be determined—in this case, by way of example, the upper inflection point L2, R2 of the bright/dark boundary HDG-li, HDG-re. By comparing the known lighting displacement (the abrupt angle transition between the two features L1 and L2) to the difference between the determined positions of the features L1 and L2, it is possible to calculate the distance of the headlights L, R to the wall 20. Distances which are determined to be different for the left and the right headlights L, R can be an indication of a non-orthogonal orientation of the motor vehicle 10 to the measurement wall 20. By comparison with saved original data for the distance between the first L1, R1 and the second feature L2, R2 on a measurement wall 20 at a distance of 10 meters for the orthogonally parked vehicle 10, it is possible to determine the current distance of the headlights L, R to the measurement wall 20. Distances of both features L1 and L2, R1 and R2, which are too small in this case, can indicate a distance of each headlight L, R from the measurement wall 20, which is too small, while distances which are too large can indicate a distance with respect to the [original] 10-meter wall which is too large. If the distances of the headlights L, R to the measurement wall 20 are known, it is possible to determine the orientation of the motor vehicle 10 to the measurement wall 20.

In FIG. 3, at this point, the same features L1, R1 of the bright/dark boundary HDG-li, HDG-re of both the left and the right headlights L, R—in this case, the lower inflection point L1, R1 of the bright/dark boundary HDG-li, HDG-re—are overlaid by means of the pivot mechanism in such a manner that the calculated distances of the two headlights L, R to the measurement wall 20 are identical, and both features L1, R1 are once again positioned in the same pixel column in the measuring range of the camera 11, and both pivot angles of the left and right headlights have the same value. The camera sighting angle α* onto this column can be stored as a reference angle 0° for the view of the camera 11 with respect to the vertical axis V. In this way, the position of the center of the vehicle on the measurement wall is discretely determined. For a stationary system, the angle information of the features L1, R1 from the left and the right headlights L, R, as measured by the camera 11 according to the position of the motor vehicle 10 with respect to the measurement wall 20, is used to determine the center position for the camera view as the preferred camera sighting angle α*.

Next, by comparing the camera sighting angle α onto the features L1, R1 with the ideal theoretical data for these features L1, R1, a referencing can be carried out for the pivoting drive. In this case, the camera sighting angles α onto one of the features L1, R1, L2, R2 of the bright/dark boundary HDG-li, HDG-re of the two headlights L, R with respect to the vertical axis V can be compared. The camera sighting angle onto the first feature L1, R1 of the bright/dark boundary HDG-li, HDG-re of the headlight, the same corresponding to the ideal position of the first feature L1, R1 in the measurement field of the camera 11, is known. By comparison with the actual measured camera sighting angle α, it can be determined whether the headlight L is pivoted out of the optimum orientation about the vertical axis V. If the camera sighting angles α agree, then the orientation of the headlight L corresponds to the optimum orientation about the vertical axis V. If a deviation is present, then the headlight L is pivoted out of the optimum position, and the measured camera sighting angle α can be saved as the new reference angle for the camera view onto the first feature L1 of this headlight L. Next, the same procedure can be carried out for the second headlight R. If the measured camera sighting angle α corresponds to the known angle, the second headlight R is optimally oriented about the vertical axis V. If there is a deviation, the second headlight R is pivoted out of the optimum position, and the measured camera sighting angle α can be saved as the new reference angle for the view onto the first feature R1 of the second headlight R. At this point, the camera sighting angles α onto the same feature L1, R1 of the bright/dark boundary HDG-li, HDG-re of the first and the second headlights L, R can be compared. If the camera sighting angles α onto the first feature L1, R1 of the first and the second headlights L, R agree, then the pivot drive is optimally adjusted.

However, if the camera sighting angles α onto the same feature L1, R1 of the bright/dark boundary HDGLi, HDGRe of the first and of the second headlights L, R do not agree, at least one of the headlights L, R is misaligned in the vertical axis V. In this case, the camera sighting angle α onto the same feature L1, R1 of the bright/dark boundary HDG-li, HDG-re of the first and the second headlight L, R, having a minimal deviation from the original value, can be taken as the target value for both headlights L, R. The previous step can be repeated. According to the invention, the pivot drives of the headlights L, R can be optimally adjusted about the vertical axis V after one repetition.

At this point, the camera sighting angles α onto the second feature L2, R2 of the first and the second headlights L, R can be compared to each other. The abrupt angle transition between the camera sighting angle α onto the first feature L1, R1 and the camera sighting angle α onto the second feature L2, R2 of a headlight L, R is predetermined by the construction thereof. If the abrupt angle transition of the camera sighting angle α is the same for the first and the second headlights L, R, then the vehicle 10 is oriented perpendicular to the wall 20. If the abrupt angle transition furthermore corresponds to that determined by the construction, then the distance to the wall 20 has been selected as the same as the distance used for carrying out the original adjustment—for example in a standard adjustment using a 10-meter wall.

If the abrupt angle transition[s] of the camera sighting angle α for the first and the second headlights L, R do not agree, then the vehicle 10 is offset with respect to the wall 20. If the abrupt angle transition for the left headlight L is smaller than the abrupt angle transition for the right headlight R, then the rear hatch of the vehicle 10 is shifted to the left. If the abrupt angle transition for the left headlight L is larger than the abrupt angle transition for the right headlight R, then the rear hatch of the vehicle 10 is shifted to the right (see FIG. 2).

Finally, the method can move on to the adjustment of the headlight range adjuster. In the case of stationary headlight systems, the step of adjusting the pivot drives is left out; at this point the method can start the adjustment of the headlight range adjusters immediately. If these features L1, R1 of the left and the right headlights L, R are positioned over each other in the same pixel column in the field of vision of the camera, at least one of the headlights L, R is set higher than the other. If the features L1, R1 of the left and the right headlights L, R exactly match, then the headlights L, R are set to the same height. With the determined vehicle orientation, the distance to the wall 20, and the orientation of the camera, the prespecified coordinates of the features L1, L2, R1, R2 of the bright/dark boundary HDG-li, HDG-re can be calculated. The headlight range adjusters can now be adjusted in such a manner that the features L1, L2, R1, R2 are translated to the calculated target coordinates.

It should be apparent to a person skilled in the art that the invention is not restricted in its implementations to the preferred embodiments given above. Rather, features from FIGS. 1 to 3 can be combined in any and every manner with each other and/or with the features from the description and/or with the features from the claims. By way of example, it can be contemplated that, as the first feature, the upper inflection point L2, R2 of the bright/dark boundary HDG-li, HDG-re according to FIG. 1 can be detected, or the inflection point of the vertical bright/dark boundary can be detected. In addition, it is possible that the preferred camera sighting angle α* according to FIG. 3 onto the upper inflection point L2, R2 of the low beam light, or onto the inflection point of the vertical bright/dark boundary, is adjusted. Already existing, characteristic features L1, L2, R1, R2 of the light distribution are advantageously detected to carry out the method according to the invention, as shown in FIG. 1. Every two-track motor vehicle permitted by ECE regulations has such a low beam light distribution as a basic light distribution. Alternatively, any other light distribution with corresponding, known features can be utilized for the adjustment method according to the invention. In this case, no modification of the conventional headlights L, R is necessary. In addition, no additional hardware need be used for implementing the method. The required software for the readjustment of the headlights L, R can be implemented in existing control devices.

The method according to the invention can also be advantageously applicable beyond just the headlight systems of a motor vehicle. Moreover, the method according to the invention can be used for various different illumination systems in aerial or nautical applications, as well as in industrial applications, where prespecified coordinates of the bright/dark boundary are produced.

The preferred embodiments of the invention have been described above to explain the principles of the invention and its practical application to thereby enable others skilled in the art to utilize the invention in the best mode known to the inventors. However, as various modifications could be made in the constructions and methods herein described and illustrated without departing from the scope of the invention, it is intended that all matter contained in the foregoing description or shown in the accompanying drawings shall be interpreted as illustrative rather than limiting. Thus, the breadth and scope of the present invention should not be limited by the above-described exemplary embodiment, but should be defined only in accordance with the following claims appended hereto and their equivalents.

### LIST OF REFERENCES

10 vehicle
11 camera
L first light device
R second light device
HDG-li bright/dark boundary of a first light distribution
HDG-re bright/dark boundary of a second light distribution
L1 first feature of the bright/dark boundary of the first light distribution
L2 second feature of the bright/dark boundary of the first light distribution
R1 first feature of the bright/dark boundary of the second light distribution
R2 second feature of the bright/dark boundary of the second light distribution
α camera sighting angle
α* preferred camera sighting angle
V vertical orientation
H horizontal orientation

1. A method for the adjustment of at least one light device, particularly of a motor vehicle, wherein the light device (L, R) serves to generate a first light distribution, wherein the first light distribution has a bright/dark boundary which has defined coordinates on a measurement wall when the light device is optimally adjusted, comprising the steps of
providing a camera said first light distribution of said light device;
detecting at least one feature of said bright/dark boundary on said measurement wall with said camera; and
adjusting said light device according to said detected feature.

2. The method according to claim 1, wherein said light device further generates a second light distribution which is different from said first light distribution, and further comprising the step of detecting at least one feature of said second light distribution with said camera.

3. The method according to claim 1, further comprising the step of detecting a second feature of said first light distribution with said camera.

4. The method according to claim 1, wherein said motor vehicle further comprises a second light device is that generates a second light distribution, and a third light distribution, and further comprising the step of at least one feature of said first light distribution and said second light distribution of said second light device with said camera.

5. The method according to claim 1, further comprising the step of positioning the motor vehicle at a distance of between 2 and 12 meters from said measurement wall and perpendicular thereto prior to detecting said at least one feature of said first light device.

6. The method according to claim 1, further comprising the step of initiating said process following a certain number of kilometers traveled by said motor vehicle.

7. The method according to claim 1, further comprising the steps of:
determining a distance between said light device and said measurement wall according to said detected feature; and
determining an orientation of said motor vehicle with respect to said measurement wall according to said detected feature.

8. The method according to claim 4, further comprising the step of comparing the detected feature for said first light device and the detected feature for said second light device (L, R), and determining an optimal orientation of said first and said second light device about a vertical axis.

9. The method according to claim 7, further comprising the step of determining an optimum orientation of said light device about a horizontal axis based on said determined distance between said light device and said measurement wall, and said determined orientation of said motor vehicle with respect to said measurement wall.

10. The method according to claim 1, further comprising the step of providing a control device operable for processing inputs from said camera and generating corresponding control commands to adjusting devices for said light device.

11. The method according to claim 1, further comprising the step of positioning the motor vehicle at a distance of between 3 to 10 meters from said measurement wall and perpendicular thereto prior to detecting said at least one feature of said first light device.

12. The method according to claim 1, further comprising the step of initiating said process after a determined duration of time that said light device has been switched on.

13. The method according to claim 1, further comprising the step of initiating said process by means of a signal from the vehicle on-board power supply.
